(19) United States
(12) Patent Application Publication
(10) Pub. No.: US 2011/0199177 A1
(43) Pub. Date: Aug. 18, 2011

(54) MULTI-STABLE ACTUATOR

(75) Inventors: Marcus Lehto, Uppsala (SE); Roger Bodén, Uppsala (SE)

(73) Assignee: MultusMEMS

(21) Appl. No.: 12/733,444

(22) PCT Filed: Aug. 29, 2008
(86) PCT No.: PCT/SE2008/050977

§ 371 Date: Mar. 2, 2010

(30) Foreign Application Priority Data
Sep. 3, 2007 (SE) 0701977-1

(51) Int. Cl. H01H 37/36

(52) U.S. Cl. 337/306

(57) ABSTRACT

A thermal actuator (1) having a plurality of passive stable states (21, 22) is provided. The thermal actuator (1) comprises an actuator body (3), an actuating arrangement (10)and a thermal control arrangement (15). The actuating arrangement further comprises a phase change material, yielding a volume change upon a change in phase of the phase change material. The actuating arrangement(10) change state due to the volume change. The thermal control arrangement (15) has at least a first and a second thermal controlling means (16, 17), wherein at lest one of themes individually controllable in order to have a localized control of the change in phase and thus the state of the actuating arrangement(10). A method for switching a thermal actuator (1) according to the invention is also presented.

### TECHNICAL FIELD OF THE INVENTION

The present invention relates to thermal actuators. In particular the present invention provides a thermal actuator having a plurality of passive stable states.

### BACKGROUND OF THE INVENTION

Actuators and actuation principles are often compared with respect to their performance in terms of force, elongation and speed. However, their applicability is also dependent on manufacturing issues, environmental issues, precision, requirements on driving, power consumption, scalability, etc. In particular, the possibility to switch between different stable states of the actuator is sought after, preferably passive stable states not having any power consumption.

Different phase transformations in materials are used for actuation purposes, e.g. phase transformations in solid phase like in shape memory alloys and the transformation from liquid state to gaseous state in therompneumatic actuators. In addition, there are so called phase change materials (PCM), which are used due to the characteristics of the melting and solidifying of the material. Often the phase change materials have a high heat of fusion, making them capable of storing or releasing large amounts of energy. This makes such materials suitable for thermal energy storage. For actuator purposes the phase change materials are interesting since the transition between the solid and liquid phases of the phase change material often is associated with a considerable volume change. Phase change materials are commonly used in thermohydraulic actuators, which results in actuators allowing high forces and high elongation, which is not the case for most actuators, simple driving and cost effective manufacturing.

Paraffin is a particularly interesting phase change material since it exhibits a very large volume change of about 10-20% upon a reversible solid to liquid transformation, even at high back pressures, has a melting temperature that can be tailored from −100 to 150° C. depending on composition, is biocompatible and is cheap. Moreover, the thermal actuation of the paraffin is easily accomplished using e.g. simple low voltage driving of resistive heaters. Paraffin mainly consists of hydrocarbon chains (alkenes) with the composition CₙH₂ₙ₊₂.

Common for most actuators and actuation principles is that they have only one passive stable state. Other stable states are active stable states that require continuous powering to sustain the stable state. This applies also for phase change actuators. Bi-stable or latching structures can be integrated in the actuating arrangement to obtain another stable state, but this is an unwanted approach since it complicates the design and the use of the actuator and increases the manufacturing cost.

### SUMMARY OF THE INVENTION

Obviously the prior art has drawbacks with regards to being able to provide an actuator which can be switched between a plurality of passive stable states.

The object of the present invention is to overcome the drawbacks of the prior art. This is achieved by the device and the method as defined in the independent claims.

In a first aspect the present invention provides a thermal actuator comprising an actuator body, an actuating arrangement, and a thermal control arrangement. The actuator body comprises a phase change material and is adapted to undergo a volume change upon a temperature dependent reversible change in phase of the phase change material. The actuating arrangement is adapted to change state due to the volume change of the actuator body. The thermal control arrangement is adapted to thermally control the actuator body and has at least a first and a second thermal controlling means. The first and the second thermal controlling means are preferably distributed along the extension of the actuating arrangement and at least one of the first and the second thermal controlling means individually controllable. Thereby the thermal control arrangement can provide localized temperature changes in order to selectively provide a plurality of stable states of the actuator arrangement.

In a second aspect the present invention provides a method for switching a thermal actuator according to the present invention. The thermal actuator comprises an actuator body comprising a phase change material, an actuator arrangement and a thermal control arrangement. Upon a temperature dependent reversible change in phase of the phase change material the actuator body undergoes a volume change. The actuating arrangement changes state due to the volume change. Furthermore, the thermal control arrangement comprises a first and a second thermal controlling means adapted to thermally control the actuator body. In a first step the method comprises melting at least partly, the phase change material of the actuator body, by heating one or both of the thermal controlling means. In a second step the method comprises initiating crystallisation of the phase change material locally by reducing the heating power of one of the thermal controlling means, with respect to the other. In a third step the method comprises controlling the propagation of the crystallisation of the phase change material by controlling the relation of heating power between the first and second thermal controlling means.

Thanks to the invention it is possible to provide an actuator providing a plurality of passive stable states that do not consume any power.

It is a further advantage of the invention to provide a simple, reliable and environmental friendly actuator suitable for positioning and fluidic and electric applications.

Embodiments of the invention are defined in the dependent claims. Other objects, advantages and novel features of the invention will become apparent from the following detailed description of the invention when considered in conjunction with the accompanying drawings and claims.

### BRIEF DESCRIPTION OF THE DRAWINGS

Preferred embodiments of the invention will now be described with reference to the accompanying drawings, wherein:

FIG. 1 is a cross sectional view of a PCM actuator according to prior art;

FIG. 2 is a cross sectional view of a thermal actuator according to the present invention;

FIG. 3 is a cross sectional view of three passive stable states for a thermal actuator according to the present invention having an actuator body enclosed in a flexible membrane;

FIG. 4a is a cross sectional view of a thermal actuator according to the present invention having a circular flexible membrane, and FIG. 4b is an illustration of the thermal actuator of FIG. 4a being switched from a first stable state to a second stable state;

FIG. 5 is a cross sectional view of a thermal actuator according to the present invention having two pistons;

FIG. 6a is a cross sectional view of a thermal actuator according to the present invention having four thermal controlling means, and FIG. 6b is a cross sectional view of a thermal actuator having a movable mirror structure;

FIGS. 7a-e are cross sectional views of positioning arrangements comprising a thermal actuator according to the present invention;

FIG. 8a is a cross sectional view of a valve arrangement comprising a thermal actuator according to the present invention, FIG. 8b is a cross sectional view of a valve arrangement comprising a thermal actuator according to the present invention having multiple outlets, and FIG. 8c is one alternative design of the valve arrangement according to FIG. 8b;

FIG. 9a is a cross sectional view of a one-way valve comprising a thermal actuator according to the present invention, and FIG. 9b illustrates a multiple-way valve comprising a thermal actuator according to the present invention;

FIG. 10 is a cross sectional view of a one-way valve comprising a thermal actuator according to the present invention having valve head structures to be closed against a valve seat;

FIGS. 11a-c are cross sectional views of electrical switch arrangements comprising a thermal actuator according to the present invention;

FIG. 12 is a cross sectional view of a thermal actuator according to the present invention having an encapsulation, and

FIG. 13 is a flow diagram of a method of switching a thermal actuator according to the invention, and

FIG. 14 is a flow diagram of one embodiment of a method of switching a thermal actuator according to the invention.

### DETAILED DESCRIPTION OF EMBODIMENTS

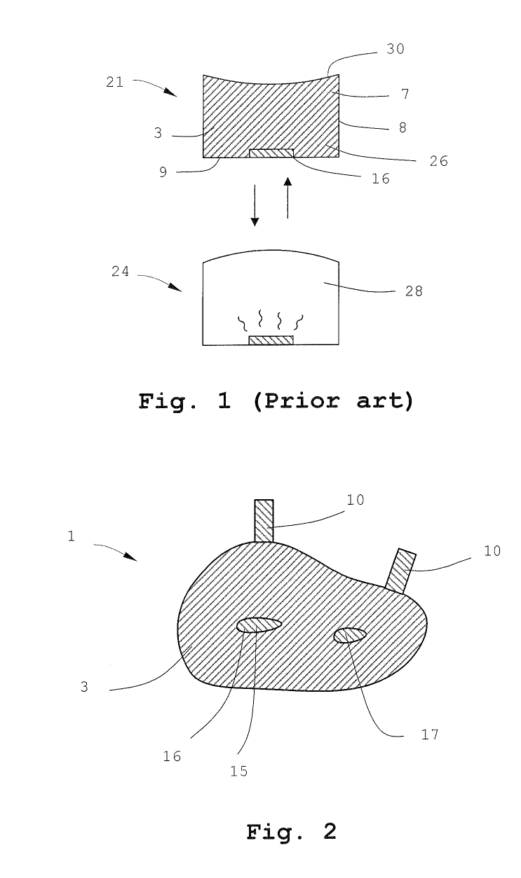

One illustrative example of a PCM actuator according to prior art is schematically illustrated in FIG. 1. The PCM actuator comprises a cylindrical cavity 7 having rigid sidewalls 8 and a rigid bottom 9. A flexible membrane 30 seals the cavity 7 and a heater 16 is located on the bottom 9. The cavity 7 is filled with a phase change material such as paraffin that defines an actuator body 3. In a passive stable state 21 the phase change material is in a solid phase 26 and the membrane 30 e.g. deflects downwards. Upon activating the heater 16 the phase change material starts to melt, i.e. there is a phase transformation from the solid state to a liquid state, yielding a considerable volume change of the actuator body 3 and consequently a change in the state of the flexible membrane 30. With the paraffin fully melted the flexible membrane 30 is fully deflected, which defines an active stable state 24 for the flexible membrane 30. In contrast to the passive stable state 21 the heater has to be continuously powered to sustain the active stable state 24. In principle the actuator only have two stable states, one passive stable state 21 and one active stable state 24.

In the following description the term “phase change material” refers to materials having a reversible phase transition between a solid and a liquid phase at a certain temperature or within a certain temperature interval yielding a volume change. Furthermore, the phase change materials have a relatively high heat of fusion. The phase change material is in the following exemplified by paraffin, which consists of hydrocarbon chains (alkenes) with the composition CₙH₂ₙ₊₂, however not limited to this. Other examples of phase change materials are polyethylene glycol, polyethylene (PE), shape memory polymers, other crystalline polymers, etc. Phase transitions in metals or metal alloys can also be used, although these materials usually require an enclosure that can withstand high temperatures, such as ceramics.

In the following the term “actuator body” refers to a body comprising at least a phase change material. The actuator body is preferentially enclosed by some structure since the phase change material at least partly will be present in the liquid state when the actuator body is used for actuating purposes.

The present invention is based on the fact that the phase change material has a solid (s) to liquid (l) phase transformation at a certain temperature yielding a volume change and that the thermal conductivity of the phase change material is fairly low. If a small volume of a melted phase change material with high thermal conductivity is considered, then the temperature at every point in the melt is essentially equal. Thus the crystallisation can in this case start anywhere in the melt. On the other hand, in a phase change material with low thermal conductivity thermal differences, i.e. thermal gradients, within the melt is possible. By sustaining the heat in parts of the melt the crystallisation can be forced to start in other parts, i.e. the parts where the temperature is the lowest. In addition, this yields for the reverse as well. With poor heat conductivity it is possible to partly melt a phase change material. Consequently, by locally controlling the temperature within the actuator body, the location and propagation of the melting ((s)→(l)) of the phase change material can be controlled. Furthermore the location of the onset, the propagation and the termination of the crystallisation ((l)→(s)) of the phase change material can be controlled. When the crystallisation starts there will be a mass transport, which moves material from the liquid to the front line of the crystallisation. Moreover, the ability for solid and liquid phase to co-exist is enhanced by a poor heat transfer between the two phases.

Referring to FIG. 2, one embodiment of the present invention is a thermal actuator 1 comprising an enclosed actuator body 3, an actuating arrangement 10, and a thermal control arrangement 15. Further, the actuator body 3 comprises at least a phase change material, which at a certain temperature has a reversible change in phase ((s)⇄(l)) that yields a volume change. Hence the actuator body 3 changes volume and/or shape when the phase change material undergoes the phase change. The actuating arrangement 10 is in contact, direct or indirect, with the actuator body 3 and adapted to be controlled by the actuator body 3. Any volume and/or shape change of the actuator body 3 will change the state of the actuating arrangement 10. The thermal control arrangement 15 is adapted to thermally control the actuator body 3, by providing localized temperature changes in the actuator body (3), and has at least a first and a second thermal controlling means 16, 17. The first and the second thermal controlling means 16, 17 are preferably distributed along the extension of the actuating arrangement 10 and at least one of the first and the second thermal controlling means [16, 17] is individually controllable. Accordingly, the shape and/or the volume of the actuator body 3 can be controlled when going from a solid phase to a liquid phase and back to the solid phase again. Hence a plurality of selectable stable states for the actuator arrangement 10 is possible in the solid phase.

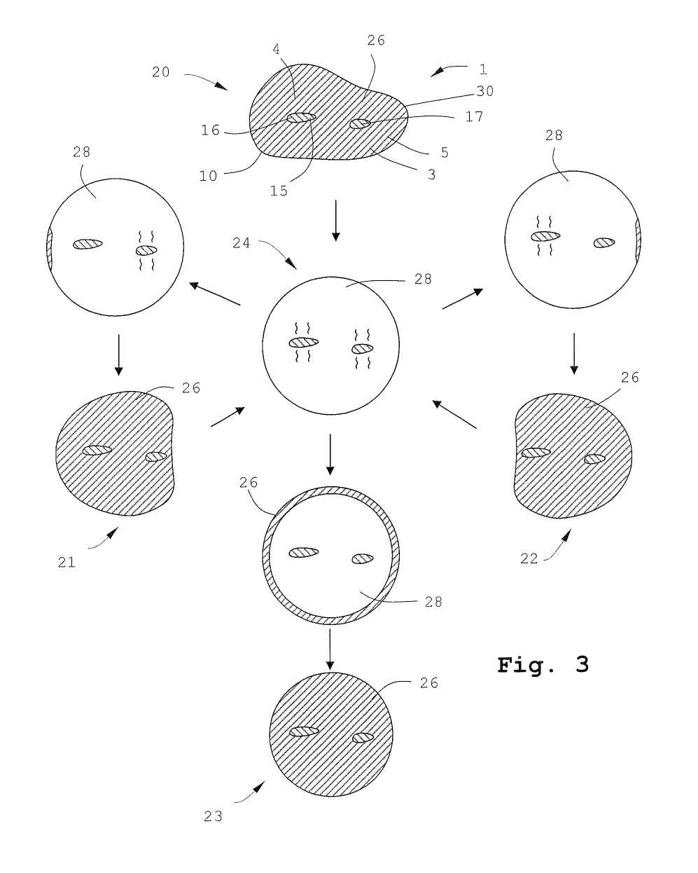

FIG. 3 schematically illustrates one embodiment of a thermal actuator 1 according to the present invention. The thermal actuator 1 comprises an actuator body 3 at least partly made of a phase change material such as e.g. paraffin. An actuating arrangement 10 in the form of a flexible membrane 30 encloses the actuator body 3. In an initial state 20 where the phase change material is in a solid phase 26, the flexible membrane, as well as the actuator body 3, has certain shape. For example this shape may have been defined in the manufacturing of the actuator, or it may be defined by a previous operation sequence. A thermal control arrangement 15 comprises at least a first and a second individually controllable thermal controlling means 16, 17 such as e.g. a resistive heater. The first and the second thermal controlling means 16, 17 are arranged along the extension of the actuating arrangement 10, i.e. the first and second thermal controlling means 16, 17 are for the sake of clarity arranged in opposite halves of the actuator body, however not limited to this. Consequently the first thermal controlling means 16 preferentially controls the temperature of a first half 4 of the actuator body 3 and the second thermal controlling means 17 preferentially controls the temperature of a second half 5 of the actuator body 3. The phase change material of the actuator body 3 starts melting, i.e. transforms from the solid phase to a liquid phase 28, and expands at a certain temperature. FIG. 3 illustrates the state of the actuator arrangement 10 during and after different heating sequences. As shown in FIG. 3 the first and the second thermal controlling means 16, 17 are firstly used to fully melt all the phase change material, i.e. transforming the solid phase 26 to the liquid phase 28. The actuator body 3 then forces the flexible membrane 30 to expand, e.g. to a sphere. This state defines an active stable state 24. Power has to be continuously supplied to sustain the shape of the flexible membrane 30 in the active stable state 24. Then, if the first thermal controlling means 16 is switched off, or at least the heating power is reduced, and the second thermal controlling means 17 is kept on, a thermal gradient between the thermal controlling means 16, 17 is formed and the solidification and crystallisation of the phase change material of the actuator body 3 will likely be initialised in an initialisation point in the peripheral part of the first half 4 of the actuator body 3. Thereby the shape of the flexible membrane 30 is at least loosely fixed in a certain state. After reducing the heating power of the second thermal controlling means 17 as well, all phase change material of the actuator body 3 solidifies in direction out from the initialisation point to establish a first stable state 21. As illustrated in FIG. 3, the actuator body 3 has changed shape and in this first stable state 21 the shape of the flexible membrane 30 has changed compared with the initial stable state 20 and the active stable state 24. On the other hand, if the second thermal controlling means 17 would have been switched off before the first thermal controlling means 16, a second stable state 22 of the actuator body 3 and the flexible membrane 30 with all the phase change material in the solid phase 26 would have had another shape than in the other stable states 20, 21, 24. Due to the symmetry in the exemplified embodiment the shape of the second stable state 22 is mirror-inverted about a vertical axis. A third stable state 23 can be obtained by melting essentially all phase change material of the actuator body 3 again with equal temperature of the thermal controlling means 16, 17 and then simultaneously switching off both the first and the second thermal controlling means 16, 17. Thereby there will be essentially a radial thermal gradient, which gives a solidification that goes from the periphery of the actuator body 3 and inwards. As shown in FIG. 3, at least three stable states 21, 22, 23 with the phase change material in the solid phase are possible, i.e. one spherical state 23 and two curved states 21, 22.

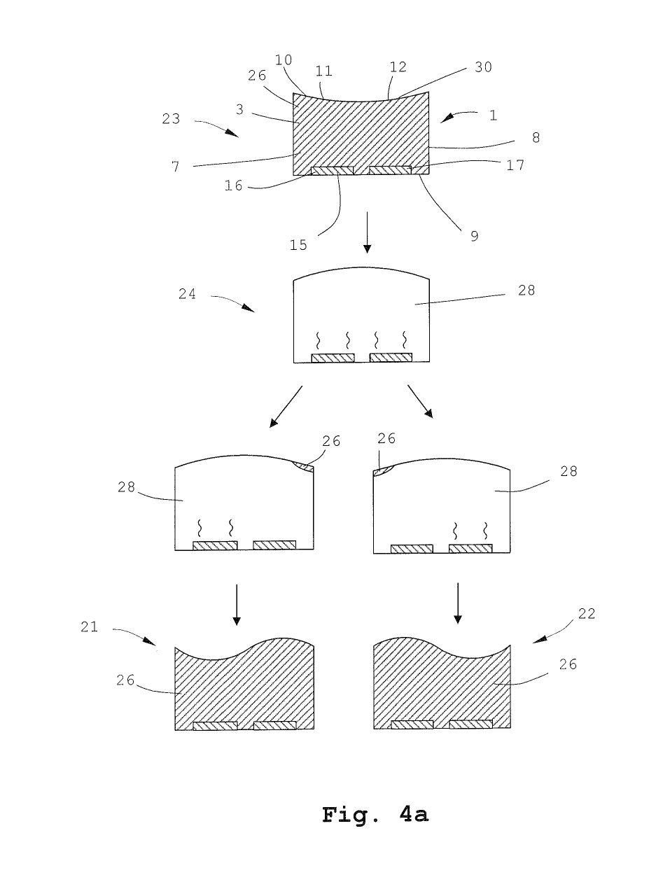

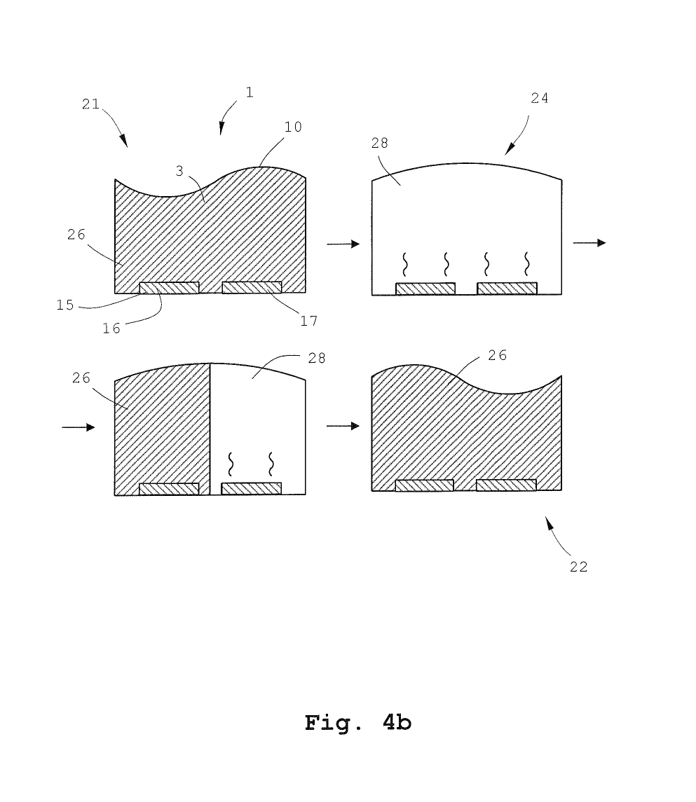

Referring to FIGS. 4a and 4b, one embodiment of a thermal actuator according to the invention comprises an actuator body 3 enclosed in a cavity 7 having rigid sidewalls 8, a rigid bottom 9 and an actuating arrangement 10 in the form of a flexible membrane 30 on top. The actuator body 3 is made of a phase change material, here exemplified by paraffin. A thermal control arrangement 15 comprising at least a first and a second individually controllable thermal controlling means 16, 17, here exemplified with heater elements 16, 17, is placed in the bottom of the cavity 7. The heater elements 16, 17 are placed on opposite halves of the bottom 9 of the cavity 7, i.e. a vertical projection of the first and second heaters 16, 17 on the flexible membrane 30 are distributed into a first and a second half 11, 12 of the flexible membrane 30. FIG. 4a illustrates two different heating sequences for the thermal actuator 1. Initially the thermal actuator 1 is in a third stable state 23. The paraffin of the actuator body 3 is in a solid phase 26 and the membrane 10 is e.g. uniformly deflected downwards. Upon activation of the first and the second heater elements 16, 17 the paraffin starts to melt, i.e. a phase transformation from the solid phase 26 to a liquid phase 28, yielding a volume change of the actuator body 3 and consequently a change in the state of the flexible membrane 30. The melting is initiated in a certain region when the temperature reaches a certain temperature. The location of this region as well as the extension of the melted region can be controlled by controlling the thermal gradient of the actuator body 3 using the heater elements 16, 17. When the paraffin has fully melted the flexible membrane 30 finds an active stable state 24 with a maximally deflected flexible membrane 30. By shutting off, or at least reducing the heating power, of the second heater 17, the solidification of the paraffin starts in the second half 12 of the flexible membrane 30. Thus, the second half 12 of the flexible membrane 30 is at least loosely fixed in a certain state. In this state the second half 12 of the membrane 10 is higher than in the third stable state 23. The solidification of the paraffin continues along a thermal gradient in the actuator body 3 to a position wherein the temperature is high enough to sustain the melt. By switching off also the first heater element 16, or at least reducing the heating power, the temperature in the remaining part of the actuator body 3 is decreased so that all paraffin solidifies and the actuator body 3 reaches a first stable state 21. Thereby the first half 11 of the flexible membrane becomes lower than in the third stable state 23 and in a cross sectional view the flexible membrane 30 describes an S-curve. If the second heater 17 would have been switched off before the first heater 16, a second stable state 22 of the actuator body 3 and the flexible membrane 30 with all the phase change material in the solid phase would have had a first half 11 of the flexible membrane 30 being higher than the second half 12 of the flexible membrane 30. Accordingly the thermal actuator has at least three stable states 21, 22, 23. Although the third stable state 23 has a membrane 30 deflecting downwards, it is not necessarily so that the membrane has to be deflected downwards in this state. The thermal actuator can be configured to e.g. have a membrane 30 deflecting upwards or being flat in the corresponding state. The relative heights of the first and second halves of the membrane 30 are also given by way of example only. FIG. 3b illustrates the switching between the second stable state 22, and the first stable state 21.

As can be observed in FIG. 4a the relative position of at least a first portion and a second portion of the flexible membrane can be shifted, i.e. in one stable state the first half 11 is elevated over the second half 12 and in another stable state the second half 12 is elevated over the first half 11. In fact, an arbitrary point on the flexible membrane can be moved in two dimensions, and even three dimensions if additional heaters are added. For example, a contact point on the membrane can be used for positioning purposes.

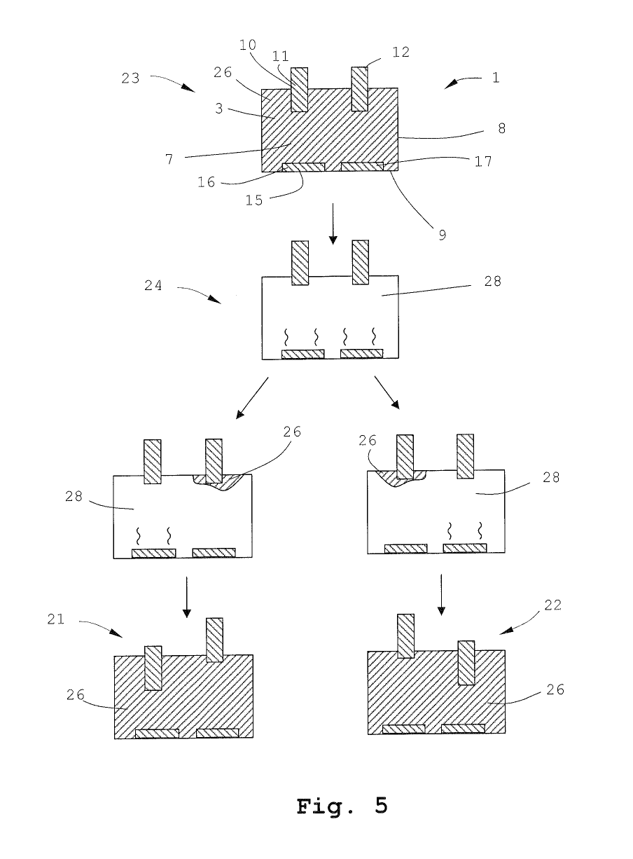

Referring to FIG. 5, one embodiment of a thermal actuator according to the invention comprises an actuator body 3 enclosed in a cavity 7 having rigid sidewalls 8, a rigid bottom 9 and an actuating arrangement 10 comprising at least a first piston 11 and a second piston 12. The pistons 11, 12 are movable and e.g. guided through holes in the sidewall 8. The actuator body 3 comprises a phase change material. By way of example the actuator body 3 is made of paraffin. A thermal control arrangement 15 comprising at least a first and a second individually controllable means 16, 17, here exemplified with resistive heater elements, are placed on the bottom 9 of the cavity 7. The first and the second heater element 16, 17 are e.g. located straight below the first and the second piston 11, 12, respectively. FIG. 5 illustrates the states for the thermal actuator during and after different heating sequences. Initially the actuator 1 is in a third stable state 23. The paraffin of the actuator body 3 is in a solid phase 26 and the pistons 11, 12 are in the same vertical position. Upon activation of the first and the second heaters 16, 17 the paraffin starts to melt, i.e. a phase transformation from the solid phase 26 to a liquid phase 28, yielding a volume change of the actuator body 3 and consequently a change in the state of the pistons 11, 12. When the paraffin has fully melted the pistons 11, 12 finds an active stable state 24, wherein the pistons are forced out to a fully extended position. By switching off the second heater 17, or at least reducing the heating power, the solidification of the paraffin starts about the second piston 12 of the actuating arrangement 10. Thus, the second piston 12 is at least loosely fixed in a certain state. In this state the second piston 12 is higher than in the first stable state 21. By switching off also the first heater element 16, or at least reducing the heating power, the temperature in the remaining part of the actuator body 3 is decreased so that all paraffin solidifies and the actuator body 3 reaches a first stable state 23. Thereby the first piston 11 of the actuating arrangement 10 becomes lower than in the third stable state 23 and the positions of the pistons 11, 12 are shifted compared to in the third stable state 23. If the second heater 17 would have been switched off before the first heater 16, a second stable state 22 of the actuator body 3 and the actuating arrangement 10 with all the phase change material in the solid phase would have had a first piston 11 being higher than the second piston 12.

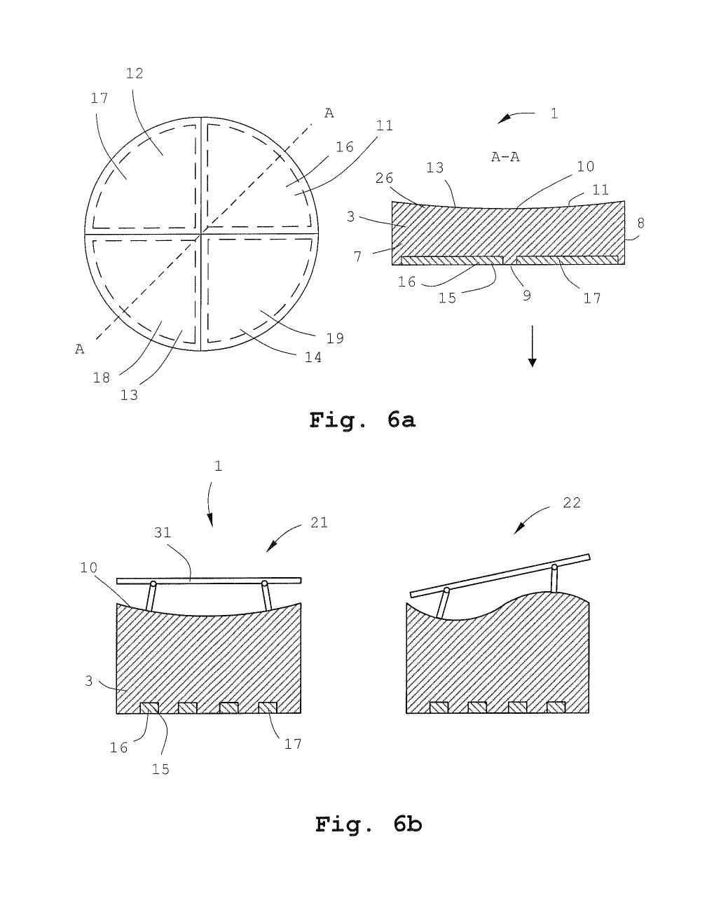

FIG. 6a schematically illustrates one embodiment of a thermal actuator 1 according to the present invention comprising a thermal control arrangement 15 having a first, a second, a third and a fourth thermal controlling means 16, 17, 18, 19. An actuator body 3 made of a phase change material is enclosed in a cavity 7 by a rigid sidewall 8, a rigid bottom 9, and a flexible membrane 30. By way of example the cavity 7 is cylindrical. The thermal controlling means 16, 17 are distributed over the surface of the rigid bottom, i.e. along the extension of the flexible membrane 30, so that each thermal controlling means 16, 17, 18, 19 occupies a quarter of the circular rigid bottom 8. A vertical projection of the thermal controlling means 16, 17, 18, 19 onto the flexible membrane 30 defines a first, a second, a third, and a fourth section 11, 12, 13, 14, each section 11, 12, 13, 14 preferentially controlled by thermal controlling means 16, 17, 18, 19, respectively. By running different pre-determined heating sequences for the thermal controlling means 16, 17, 18, 19, essentially nine basic stable states having the phase change material in a solid phase 26 is possible since each section 11, 12, 13, 14 of the flexible membrane 30 may be in an upper or an lower position, or all of the sections in a middle position simultaneously. From this it can be understood that not only the position of a discrete section of the actuating arrangement 10 is useful, but also the topography of the actuating arrangement 10. According to the present invention the topography of e.g. a flexible membrane 30 can be controlled. Referring to FIG. 6b, one alternative embodiment comprises a mirror structure arranged on the flexible membrane 30. As shown in FIG. 6b, posts 34 protruding from the flexible membrane are joined with a mirror structure 31. By arranging the flexible membrane 30 in different stable states the normal of the mirror structure 31 is pointing in different directions. This can be used to position e.g. a laser beam in a pre-defined direction and passively sustaining the direction. Commonly an electrostatic actuator is used for such a task, but the electrostatic actuator typically requires a continuous powering to sustain the position of the laser beam.

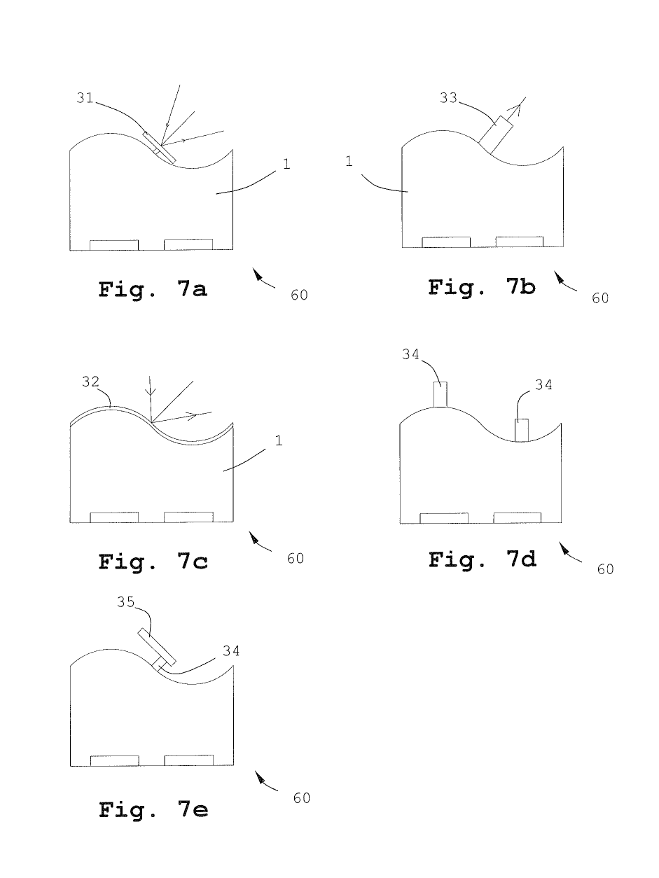

FIGS. 7a-e illustrates positioning arrangements 60 comprising a thermal actuator according to the present invention. By way of example the thermal actuator comprises an actuator body 3 enclosed in a cavity 7 having rigid sidewalls 8, a rigid bottom 9 and an actuating arrangement 10 comprising a flexible membrane 30 on top. The actuator body 3 is made of paraffin. A thermal control arrangement 15 comprising at least a first and a second individually controllable heater element 16, 17 is placed in the bottom of the cavity 7. The cross sectional views in FIGS. 7a-e show that the heaters 16, 17 are distributed along the extension of the membrane 10 along the bottom 9 of the cavity 7. Referring to FIG. 7a, one embodiment of the positioning arrangement of the present invention further comprises a mirror structure 31 mounted via a post 34 onto the flexible membrane 30. By arranging the flexible membrane in different states the inclination of the post 34 and thus the inclination of the mirror structure 31 can be altered, which can be used to position a light beam. Referring to FIG. 7b, another embodiment of the positioning arrangement 60 of the present invention further comprises a light source 33 mounted directly onto the flexible membrane 30. The direction of illumination from the light source 33 can be directed in different directions depending on the state of the flexible membrane 30. Referring to FIG. 7c, yet another embodiment of the positioning arrangement further comprises a reflective surface coating 32 on the top surface of the flexible membrane 30. The reflective surface coating 32 can be used as a mirror surface. The topography and hence the direction of the reflected light can be controlled by controlling the state of the actuating arrangement 10, i.e. by controlling the melting and solidification of the paraffin of the actuator body 3. Referring to FIG. 7d, in one embodiment of the positioning arrangement 60 according to the present invention the actuating arrangement is suitable for mechanical positioning rather than optical positioning. The positioning arrangement 60 comprises rigid posts 34 protruding from the flexible membrane 30. Referring to FIG. 7e, in one alternative embodiment the actuating arrangement 10 comprises a post 34 and a beam 35 arranged onto the post.

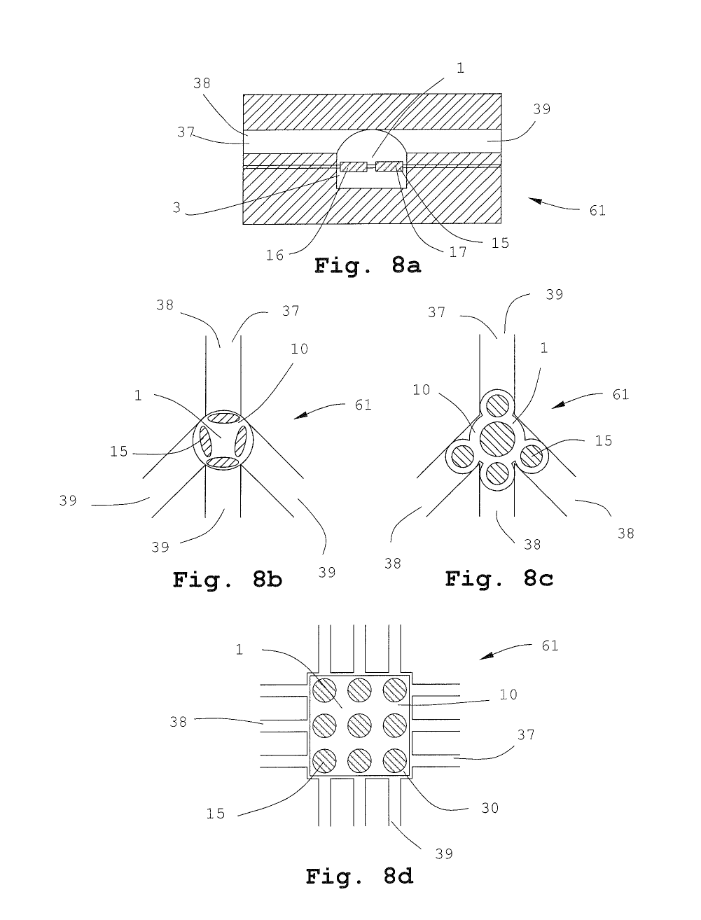

Pneumatic, thermopneumatic and hydraulic actuators are commonly used in fluidic systems. As stated above, phase change materials, such as e.g. paraffin, exhibit a large volume change in the transition between solid and liquid phase. One obvious advantage of this phase transition compared with the commonly used liquid to gas transition, which often gives a much greater volume expansion, is that the liquid is much less compressible than the gas. Hence the solid to liquid transition gives a much more powerful actuator. In particular paraffin is an interesting actuator material since the maximum temperature of the paraffin during operation can be chosen so that it is well below any limit that is set for the fluid to be handled. In FIGS. 8-10 embodiment of valve arrangements 61 comprising a thermal actuator according to the present invention are schematically illustrated.

Referring to FIG. 8a, one embodiment of a valve arrangement 61 comprising a thermal actuator 1 according to the present invention has an actuator body 3 enclosed in a cavity 7 having rigid sidewalls 8, a rigid bottom 9 and an actuating arrangement 10 comprising a flexible membrane 30 on top. The actuator body 3 is by way of example made of paraffin. A thermal control arrangement 15 comprising at least a first and a second individually controllable heater element 16, 17 is placed between the bottom of the cavity 7 and the flexible membrane 30. A fluidic channel 37 having an inlet 38 and an outlet 39 is arranged on the flexible membrane 30 so that the membrane 30 upon melting of the paraffin deflects into the fluidic channel 37. Such a valve arrangement 61 can be used in fluidic applications, both for handling gas flows and liquid flows. The fluidic channel 37 can be designed with a valve seat that fits on the deflected membrane 30 to obtain leak-free valves or the thermal actuator can be used for adjusting a flow speed only. The thermal actuator can be designed as a stand alone device or integrated on-chip.

Referring to FIG. 8b, one embodiment of a valve arrangement 61 comprising a thermal actuator 1 according to the present invention has a fluidic channel 37 with one inlet and three outlets 39; however, the number of outlets 39 and inlets 38 are not limited to this. The thermal actuator 1 comprises an actuator arrangement 10 in the form of a flexible membrane positioned at the crossing of the inlet/outlets. The thermal actuator 1 further comprises a thermal control arrangement 15 having four thermal controlling means distributed along the flexible membrane 30. A vertical projection of the four thermal controlling means onto the flexible membrane 30 defines four sections, each section preferentially controlled by one thermal controlling means. By running different pre-determined heating sequences for the thermal controlling means opening and closing of the inlet/outlets can be controlled so that a fluid flow from the inlet 38 can be directed to any of the outlets 39. FIG. 8c, illustrates one alternative embodiment of a valve arrangement 61 comprising a thermal actuator 1 having three inlets 38 and one outlet 39. Moreover the thermal control arrangement 15 comprises five thermal controlling means. The functionality is however merely the same as for the embodiment illustrated in FIG. 8b.

Referring to FIG. 8d, one embodiment of a valve arrangement 61 comprising a thermal actuator 1 is functional as a multiple-way microfluidic valve, which re-directs fluid flows from an inlet array to an outlet array. Each array comprises a plurality of inlets/outlets 38, 39. The thermal actuator 1 comprises an actuator body 3 enclosed in a cavity 7 having rigid sidewalls 8, a rigid bottom 9 and an actuating arrangement 10 comprising a square flexible membrane 30 on top. A thermal control arrangement 15 comprising a two-dimensional array of individually controllable thermal controlling means is placed on the bottom of the cavity 7. Each thermal controlling means essentially controls one section each of the flexible membrane 30. The heating and cooling of the actuator body 3 can be controlled so that certain sections are blocking the way for a fluid flow that flow out from an inlet in the inlet array, whereby the laminar flow is directed in a perpendicular direction. Thereby a flow from one inlet in the inlet array can be directed into any of the outlets in the outlet array.

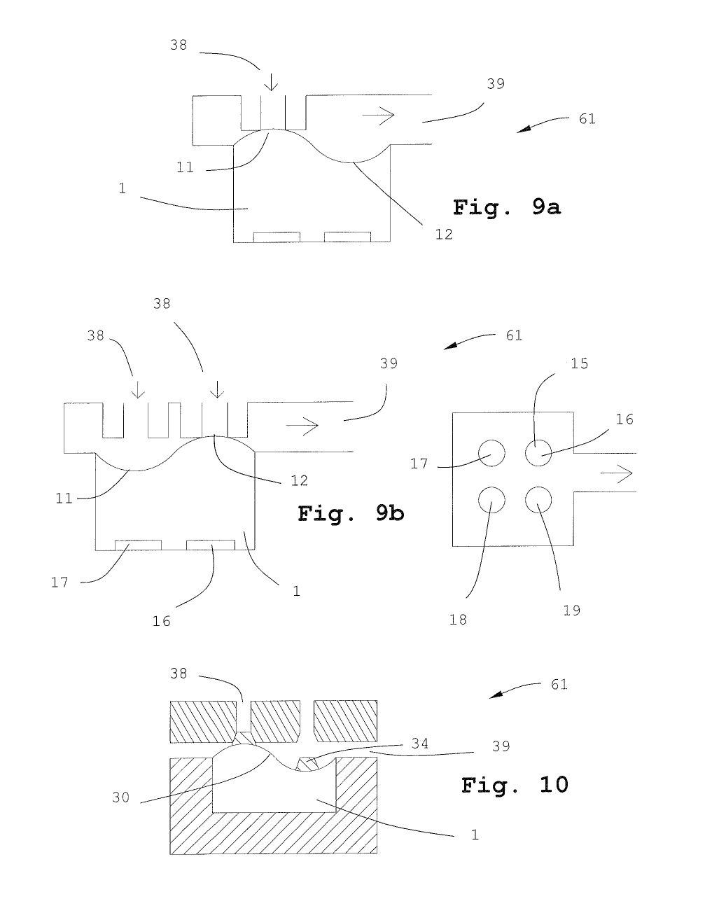

FIG. 9a schematically illustrates one embodiment of a valve arrangement 61 comprising a thermal actuator 1 according to the present invention. The valve arrangement 61 is functional as a valve having a vertical inlet 38 and a horizontal outlet 39. The thermal actuator 1 comprises an actuator body 3 enclosed in a cavity 7 having rigid sidewalls 8, a rigid bottom 9 and an actuating arrangement 10 e.g. in the form of a flexible membrane 30 on top. The actuator body 3 comprises a phase change material. A thermal control arrangement 15 comprising at least a first and a second individually controllable thermal controlling means 16, 17, here exemplified by a first and a second heater element 16, 17, however not limited to this. The heater elements 16, 17 are placed in the bottom of the cavity 7. The heater elements 16, 17 are by way of example placed on opposite halves of the circular bottom 9 of the cavity 7, i.e. the vertical projection of the first and second heaters 16, 17 on the flexible membrane 30 are distributed into a first and a second half 11, 12 of the flexible membrane 30. The cross sectional view in FIG. 9a illustrates a first stable state 21 of the actuator 1, wherein the flexible membrane 30 is S-shaped, having a first section 11 being deflected upwards, and a second section 12 being deflected downwards. The first section 11 then closes an inlet 38. By transformation into a second stable state 22 the first section 11 of the flexible membrane 30 is lowered away from the inlet and the valve opens to let a fluid flow from the vertical inlet 38 to the horizontal outlet 39. Referring to FIG. 9b one alternative embodiment is functional as a two-way valve. At least a second inlet 38 is arranged in parallel with the first inlet 38. The heaters are distributed along the membrane so that one heater is placed under the first inlet and the other is placed under the second inlet. As shown in FIG. 3 the flexible membrane 30 has essentially three stable states, wherein the paraffin is in the solid phase. The three states correspond to having: the first inlet open and the second closed; both inlets open; and the first inlet closed and the second inlet open. The two-way valve approach can be extended to a multiple-way valve approach by adding inlets and heaters. A top view of such an arrangement comprising four heater elements is illustrated in FIG. 9b. The four heater elements control four inlets leading to one common outlet.

FIG. 10 illustrates one embodiment of a valve arrangement 61 comprising a thermal actuator 1 functional as a two-way valve having two vertical inlets 38 and a horizontal outlet 39. Two valve head structures, each adapted to fit into the valve inlets, are mounted onto the flexible membrane. The flexible membrane 30 has at least three stable states adapted to control the opening and closing of the inlets 38.

In one embodiment of the present invention the thermal actuator 1 is used in an electrical switching arrangement. The actuator arrangement 10 of the thermal actuator 1 is adapted to change state in order to vary the distance between a first electrical contact and a second electrical contact. The distance can be varied between at least two stable states, but by e.g. adding thermal controlling means additional stable states can be provided. In addition, the distance can be continuously varied using active states. The stable states of the electrical switching arrangement may be adapted to provide an on-position and an off-position, i.e. the distance between the electrical contacts can be varied in order to switch from an on-position to an off-position. Typically the electrical contacts are closed in the on-position and open in the off-position.

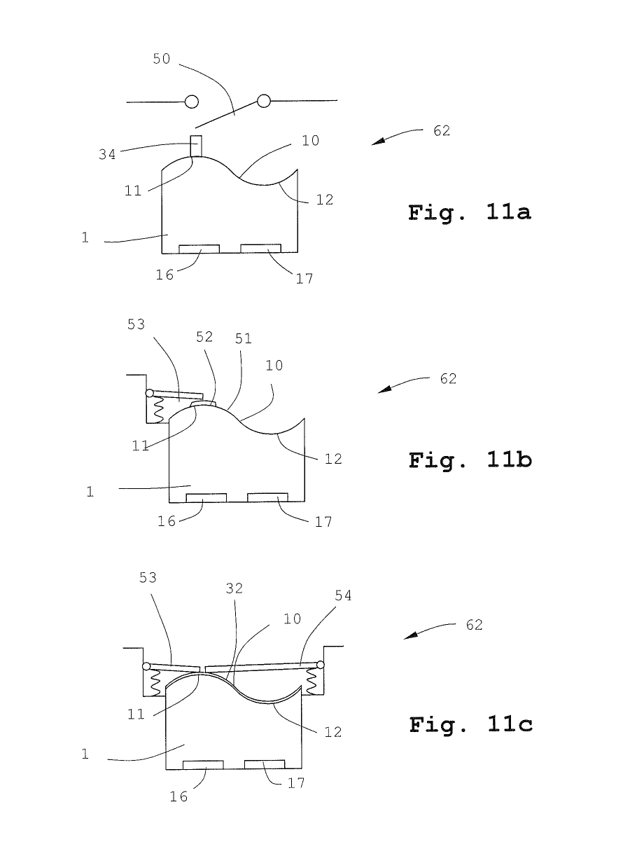

FIGS. 11a-c illustrates one embodiment of an electrical switch arrangement 62 comprising a thermal actuator according to the present invention. The thermal actuator 1 of the three embodiments comprises an actuator body 3 enclosed in a cavity 7 having rigid sidewalls 8, a rigid bottom 9 and an actuating arrangement 10 comprising a flexible membrane 30 on top. The flexible membrane has a first section 11 and a second section 12 corresponding to the halves of the flexible membrane 30. The actuator body 3 is made of a phase change material. A thermal control arrangement 15 comprising at least a first and a second individually controllable heater element 16, 17 are distributed along the bottom 9 so that the first heater 16 is under the first section 11 and the second heater is under the second section 12. The flexible membrane has at least three stable states wherein all phase change material of the actuator body 3 is in a solid phase. In a first stable state 21 the flexible membrane is S-shaped with the first section 11 being convex and the second section 12 being concave. In a second stable state 22 the flexible membrane is S-shaped with the first section 11 being concave and the second section 12 being convex. In a third stable state 23 the flexible membrane 30 is deflected inwards. FIG. 11a schematically illustrates a cross sectional view of one alternative embodiment further comprising a post 34 arranged on a first section 11 of the flexible membrane 30 and an electrical switch 50 arranged above the post 34. In the first stable state 21 the post 34 is in its highest position and the electrical switch is closed. In the second stable state 22 the post 34 is in its lowest position and the electrical switch is open. FIG. 11b schematically illustrates a cross sectional view of another alternative embodiment further comprising circuits 51 on the flexible membrane 30 having a contact 52 in the first section 11 and a flexible connector 53 arranged above the contact 52. In the first stable state 21 the first section 11 is in its highest position and the contact 52 is pressed against and in electrical contact with the flexible connector 53. In the second stable state 22 the first section 11 is in its lowest position and the contact 52 is withdrawn and not in electrical contact with the flexible connector 53. FIG. 11c schematically illustrates a cross sectional view of yet another alternative embodiment further comprising a conductive surface coating 32, which at least partly covers the first section 11 of the flexible membrane 30, and a first flexible connector 53 and a second flexible connector 54 arranged above the first section 11. In the first stable state 21 the first section 11 is in its highest position and the flexible connectors 53, 54 are pressed against the surface coating 32 on the flexible membrane 30. Thereby the surface coating brings the flexible connectors 53, 54 in electrical contact. In the second stable state 22 the first section 11 is in its lowest position and the flexible connectors 53, 54 are not in electrical contact. The electrical switch arrangement 62 according to the present invention can be used as a switch or a relay, which can be locked in a position, without any mechanical latches. It can for example be used in application where electromagnetic actuators are used today. The electromagnetic actuators usually need continuous powering to stay in a certain position. The thermal actuator of the present invention can be locked without feeding any power in the stable state. Moreover the phase change material provides a very high power. In combination with the possibility to obtain a gliding motion in the contact this can be used to penetrate oxidised contacts.

The temperature control of the actuator body 3 is dependent on the heat transfer within the actuator and the heat dissipation. Heat is transferred by heat radiation, convection, and conduction. The thermal conductivity of the phase change material is preferably low, but can be adjusted by blending the phase change material with particles having a higher thermal conductivity. More important is that the heat dissipation can be controlled or increased by using heat sink elements. In fact, all structures that enclose the actuator and other structures, such as valve seats, posts, etc, in contact with the actuator body works as heat sinks, conducting heat to the surroundings. The heat dissipation is crucial for the speed of the actuator 1. The actuator can easily be heated at a high rate, but the cooling is more complicated due to the low thermal conductivity of the phase change material. The heat sink elements are preferably made of a material with high heat capacity, e.g. a metal or metal alloy. The convection may be improved by having an appropriate surface structure. The heat sink element may be connected to an active cooling/heating system. Peltier-elements can also be used to actively cool or heat the actuator body.

Referring to FIG. 12, in one embodiment of the present invention the thermal actuator 1 is integrated in a substrate 29 having a cavity 7. The cavity 7 has rigid sidewalls 8 and a rigid bottom 9 and is filled with a phase change material. The cavity 7 is sealed by a flexible membrane 30. A first and a second resistive heater 16, 17 are distributed along the membrane on the bottom 9 of the cavity. In addition the thermal actuator comprises an encapsulation 36, which at least partly covers the thermal actuator 1. The encapsulation 36 encloses and shields a small volume above the actuator 1, whereby the control of the convection of heat is improved. Without an encapsulation 36 the convection through the parts exposed to the surrounding environment may be sensitive to changes in the environment. With the encapsulation 36 the stability of the actuator 1 is improved. The encapsulation 36 may be hermetically sealed.

In general, the embodiments described above comprise two thermal controlling means 16, 17 and the actuating arrangement 10 comprises either a flexible membrane 30 or two pistons 11, 12. Moreover the thermal controlling means are more or less described as having two discrete states, i.e. on and off, which gives three stable states 21, 22, 23 for the actuating arrangement 10. However, the present invention is not limited to this. The number of thermal controlling means 16, 17 is not limited and the thermal gradient in the actuator body can be controlled in more than one dimension and with more than two possible discrete states for the actuating arrangement 10. In principle the thermal actuator of the present invention can be regarded as an analogue switch, having an infinite number of stable states. The thermal gradient in the actuator body and hence the stable states can be controlled by supplying the appropriate amount of power to or from the thermal controlling means 16, 17. Moreover the number of thermal controlling means 16, 17 can be increased and the location of the thermal controlling means is not limited to e.g. the bottom of the cavity 7, as described above. In fact it is often advantageous to place heaters in the middle of the cavity 7 e.g. to be able to faster melt the complete actuator body 3. Furthermore, the thermal controlling means may be placed freely in three dimensions within the actuator body 3. Although the actuating arrangement 10 has been exemplified as being a single circular flexible membrane 30 in the embodiments described above the actuating arrangement 10 is not limited to this. The shape and the number of membranes may be varied. Combinations of pistons, membranes and other structures are also possible. In addition, a flexible membrane 30 can be locally modified with respect to thickness, stiffness, etc. The different states of the flexible membrane are also dependent on the design and the manufacturing of the actuator. For example, a thermal actuator according to FIG. 4a may be filled with different amounts of phase change material. The membrane may e.g. be deflected upwards in the so called third stable state 23.

The actuating arrangement 10 has been described in terms of flexible membranes 30 having different sections and halves, and the actuator body 3 has been described in terms of having hemispheres or halves, the section, hemispheres and halves essentially being controlled by different thermal controlling means. These descriptions should not be understood as the thermal controlling means are limited to control the temperature of only a certain region. In fact, each thermal controlling means can contribute to the heating/cooling of any part of the actuator body. However, each thermal controlling means 16, 17 primarily affect the phase change material in the vicinity thereof. Hence the thermal controlling means 16, 17 can be described as controlling a certain section of the actuating arrangement 10 or a certain region of the actuator body 3.

The thermal controlling means 16, 17 comprises e.g. passive heat sinks, resistive heaters, Peltier-elements, etc. One alternative is to supply heat to the actuator body using light, which is projected to a certain region of the actuator body 3 or swept over at least a portion of the actuator body 3. Combinations of different kinds of thermal controlling means are also possible. For example, heat sink elements may be introduced in combination with heater elements to improve the speed of the actuator.

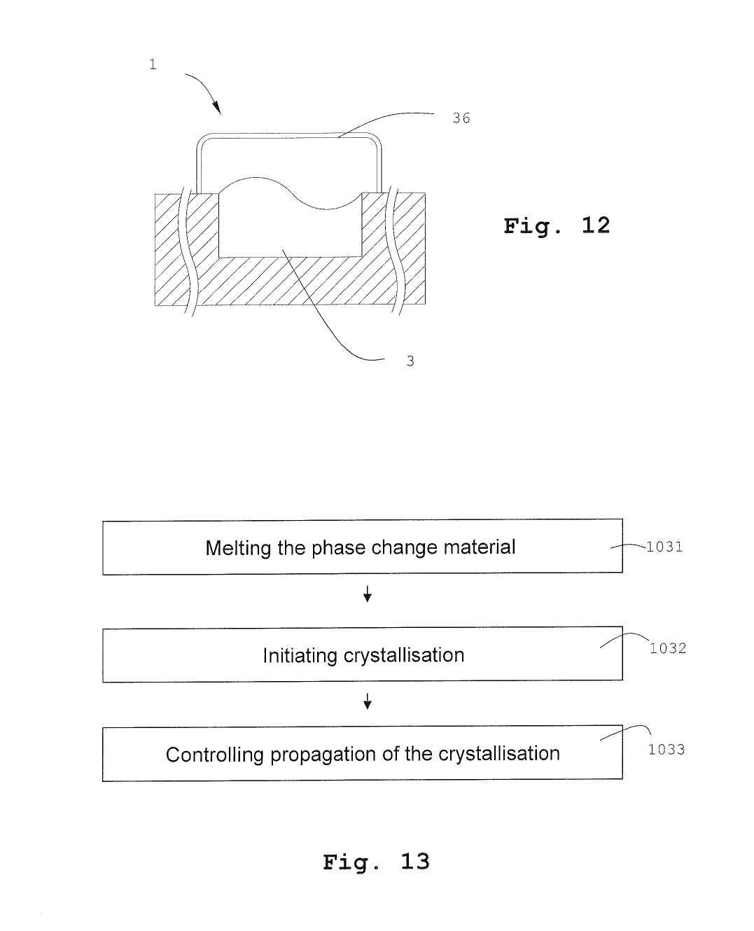

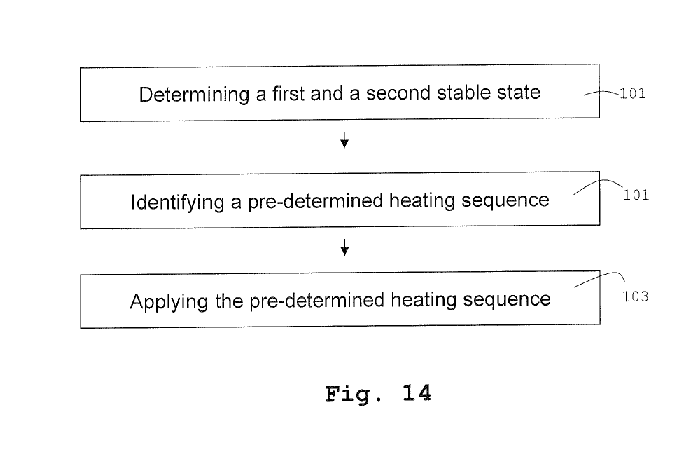

FIG. 13 is a flow diagram of one embodiment of a method of switching a thermal actuator 1 according to the present invention. The thermal actuator 1 comprises an enclosed actuator body 3, an actuating arrangement 10 and a thermal control arrangement 15. Further the actuator body 3 comprises a phase change material and the actuator body 3 undergoes a volume change upon a temperature dependent reversible change in phase of the phase change material. The thermal control arrangement 15 comprises a first and a second thermal controlling means 16, 17. The method comprises the steps of:
1031 melting at least partly, the phase change material of the actuator body 3, by heating one or both of the thermal controlling means 16, 17;
1032 initiating crystallisation of the phase change material locally by reducing the heating power of one of the thermal controlling means 16, 17, with respect to the other; and
1033 controlling the propagation of the crystallisation of the phase change material by controlling the relation of heating power between the first and second thermal controlling means 16, 17.

The order of the steps, as well as the heating power relations between the first and second thermal controlling means 16, 17 will be dependent on a first and a second state 21, 22 of the actuating arrangement 10.

Referring to FIG. 14, the method may further comprise the following steps, to be taken prior to the steps of melting, initiating and controlling the crystallisation propagation:
101 determining a first and a second stable state 21, 22 for the actuating arrangement 10;
102 identifying a pre-determined heating sequence relating to the first and the second stable state. The first heating sequence comprises instructions of the order of the melting, initiating and controlling the crystallisation steps and the relation between the heating power of the thermal controlling means 16, 17 in respective step; and
103 applying the identified pre-determined heating sequence to bring the actuating arrangement 10 from the first stable state 21 to the second stable state 22.

As explained above the phase change material of the actuator body 3 undergoes a volume change in the transition between a solid phase and a liquid phase, i.e. melting and crystallisation. The volume change of the phase change material changes the state of the actuating arrangement 10. Furthermore the phase change material of the actuator body 3 can be redistributed by controlling the temperature gradients in the actuator body 3 so that a solid phase and a liquid phase co-exist. Then there will be a mass transport, which moves material from the liquid to the frontline of the crystallisation. Thereby different shapes of the actuator body 3 and different states of the actuating arrangement 10 can be obtained. Using the first and the second thermal controlling means 16, 17 at least three stable states with the phase change material in the solid phase can be obtained. The phase change material is at least partly melted to accomplish a redistribution of the phase change material in the actuator body 3 and a controlled crystallisation to switch between the at least first and second stable states 21, 22.

Referring to FIG. 4a and FIG. 4b, in one embodiment of the method according to the present invention the thermal actuator is switched between a first passive stable state 21 and a second passive stable state 22. In step 101, the first and the second stable state 21, 22 for the actuator arrangement are determined according to FIG. 4a and FIG. 4b. In step 102 a pre-determined heating sequence is identified. The heating sequence comprises instructions of the order of the melting, initiating and controlling the crystallisation steps and the relation between the heating power of the thermal controlling means 16, 17 in order to redistribute the phase change material of the actuator body 3 properly. In step 103 the identified pre-determined heating sequence is applied to bring the actuating arrangement 10 from the first stable state to the second stable state. As schematically illustrated in FIG. 4b the phase change material of the actuator body 3 is fully melted by the first and the second thermal controlling means 16, 17 (step 1031). Thereby the membrane is deflected upwards to a maximally deflected state. This defines an active stable state 24, wherein power has to be supplied to the thermal controlling means continuously to be able to sustain this state. However, this is given by way of example only. The phase change material in some case only has to be partly melted to find be able to go from the first stable state to the second stable state. Thereafter the crystallisation of the phase change material is locally initiated adjacent a first half 3 of the actuator arrangement 10 by reducing the power of at least the second thermal controlling means 17. Thereby the state of the first half of the actuator arrangement 11 is at least loosely fixed. The propagation of the crystallisation is controlled by controlling the relation of heating power between the first and second thermal controlling means 16, 17 so that the actuator arrangement 10 finally reaches the second stable state 22. In alternative embodiments the thermal controlling means 16, 17 are controlled so that the thermal actuator is switched between the first stable state 21 and the third stable state 23, the second stable state 22 and the third stable state 23, etc. The states 21, 22, 23 illustrated in FIG. 4a are by way of example only. In principle the thermal actuator works as an analogue device having an infinite number of possible states. These embodiments of the method according to the invention can be applied on the thermal actuator 1 comprising an actuator arrangement with pistons 11, 12 that is illustrated in FIG. 5 as well. In FIG. 4a and FIG. 4b, the actuator arrangement 10 comprises a flexible membrane 30. The pistons 11, 12 in FIG. 5 in principle behave as the two halves 11, 12 of the membrane 30 in FIGS. 4a and 4b.

In the embodiments of the method according to the present invention described above the first and the second stable states 21, 22 are in a solid phase 26. In one alternative embodiment according to the method of present invention the second stable state 22 of the actuator arrangement 10 is an active stable state 24, wherein the phase change material at least partly is in a liquid phase 28. The remaining part is in solid phase 26. At least one of the thermal controlling means 16, 17 has to be continuously powered to sustain the active state 24. This was explained as a middle state in the embodiment described above, however this may be a final state as well. All of the phase change material of the actuator body 3 may be melted in the active state 24. The control of such a state is usually less complicated than for a state wherein the phase change material is partly melted since there will be a continuous crystallisation melting such a case.

In one embodiment of the method according to the present invention the thermal controlling means 16, 17 are adjusted to obtain a deviation from the pre-determined stable state 21, 22, 23, 24. In one alternative embodiment the actuating arrangement 10 is in a stable state 21, 22, 23, 24 with all of the phase change material in a solid phase 26. A deviation from the first stable state 21 may in some cases be wanted, e.g. for fine-tuning. To accomplish the fine-tuning the actuator body 3 is thermally controlled by adjusting the thermal controlling means 16, 17 so that: the actuator body 3 at least partly expands thermally, although without changing the phase of the phase change material; the phase change material locally changes to another solid phase, yielding a local volume change; or the phase change material locally transforms from the solid phase to the liquid phase, yielding a local volume change. All changes in volume affect the state of the actuating arrangement. In another variant of this embodiment the active stable state 24, wherein the phase change material at least partly is in the liquid state, may be adjusted by increasing or decreasing the extension of the liquid part. This embodiment can for example be used when the originally determined stable states 24 are deviating due to e.g. applied load or deviations in the surrounding temperature.

The actuating arrangement 10 is typically connected to power source, supplying the thermal controlling means with appropriate power. The power source is in turn connected to a controller, which for example is realized by a microprocessor of conventional type. The controller is adapted to keep track of the state of the actuating arrangement 10, to receive instructions of a wanted final stable state. The controller preferably stores pre-determined heating sequences bringing the actuating arrangement 10 from one specific current state to a specific final state, and the controller is adapted to identify the correct pre-determined heating sequence based on a current state and a wanted final state. The identification can be made with a straightforward use of a concordance list relating all possible transitions from a current state to a final state with the appropriate heating sequence.

While the invention has been described in connection with what is presently considered to be the most practical and preferred embodiments, it is to be understood that the invention is not to be limited to the disclosed embodiments, on the contrary, is intended to cover various modifications and equivalent arrangements within the appended claims.

1. A thermal actuator comprising:
an actuator body comprising a phase change material, wherein the actuator body is adapted to undergo a volume change upon a temperature dependent reversible change in phase of the phase change material;
an actuating arrangement adapted to change state due to the volume change of the actuator body; and
a thermal control arrangement comprising at least a first and a second thermal controlling means, wherein at least one of the first and the second thermal controlling means is individually controllable and the thermal control arrangement is adapted to provide localized temperature changes in the actuator body in order to selectively provide a plurality of stable states of the actuator arrangement.

2. The thermal actuator according to claim 1, wherein the actuating arrangement comprises at least one flexible membrane.

3. The thermal actuator according to claim 2, wherein the relative position of at least a first portion and a second portion of the flexible membrane can be shifted with respect to each other.

4. The thermal actuator according to claim 1, wherein the actuating arrangement comprises at least one piston.

5. The thermal actuator according to claim 1, wherein at least one of the temperature controlling means comprises a heater element or a heat sink element.

6. The thermal actuator according to claim 1, wherein the actuator body is enclosed in a closed cavity by rigid sidewalls, a rigid bottom, and the actuating arrangement.

7. The thermal actuator according to claim 1, wherein the phase change material of the actuator body comprises paraffin.

8. The thermal actuator according to claim 2, wherein the flexible membrane comprises a surface coating, which is reflective or electrically conductive.

9. A valve arrangement comprising the thermal actuator according to claim 1, wherein the valve arrangement comprises a fluidic channel and the actuating arrangement of the thermal actuator is adapted to control a fluid flow in the fluidic channel.

10. An electrical switching arrangement comprising the thermal actuator according to claim 1, wherein the actuator arrangement is adapted to change state in order to vary a distance between a first electrical contact and a second electrical contact.

11. An electrical switching arrangement according to claim 10, wherein the distance between the electrical contacts can be varied in order to switch from an on-position to an off-position.

12. A method for switching a thermal actuator,
wherein the thermal actuator comprises:
an actuator body comprising a phase change material;
an actuating arrangement; and
a thermal control arrangement comprising at least a first and a second thermal controlling means; and the method comprises—the steps of:
melting at least partly, the phase change material of the actuator body, by heating one or both of the thermal controlling means;
initiating crystallisation of the phase change material locally by reducing a heating power of one of the thermal controlling means with respect to the other;
controlling a propagation of a crystallisation of the phase change material by controlling a relation of heating power between the first and second thermal controlling means.

13. The method for switching a thermal actuator according to claim 12, further comprising the steps, to be taken prior to the steps of melting, initiating and controlling the crystallisation propagation, of:
determining a first and a second stable state for the actuating rrangement;
identifying a pre-determined heating sequence relating to the first and second stable state, the heating sequence comprising instructions of the order of the steps of melting, initiating and controlling the crystallisation propagation and the relation between the heating power of the thermal controlling means in respective step;
applying the identified pre-determined heating sequence to bring the actuating arrangement from the first stable state to the second stable state.

14. The method for switching a thermal actuator according to claim 13, wherein the second stable state is a passive stable state and the phase change material is in a solid phase.

15. The method for switching a thermal actuator according to claim 13, wherein the second stable state is an active stable state and the phase change material at least partly is in a liquid phase.
